(19) United States
(12) Patent Application Publication
(10) Pub. No.: US 2017/0074206 A1
(43) Pub. Date: Mar. 16, 2017

(54) PISTON

(71) Applicant: BINZHOU DONGHAILONG PISTON CO., LTD, Binzhou (CN)

(72) Inventors: Weibin ZHANG, Binzhou (CN); Jianjun LIU, Binzhou (CN); Shengkun WANG, Binzhou (CN); Jinyu JI, Binzhou (CN)

(21) Appl. No.: 15/361,348

(22) Filed: Nov. 25, 2016

Related U.S. Application Data
(63) Continuation-in-part of application No. PCT/CN2014/001121, filed on Dec. 15, 2014.

(30) Foreign Application Priority Data
May 26, 2014 (CN) 201410223859.9

(51) Int. Cl. F02F 3/18; F02F 3/26; F02F 3/00

(52) U.S. Cl. CPC F02F 3/18; F02F 3/003; F02F 3/26; F02F 2003/0061

(57) ABSTRACT

A piston, including a piston head, a piston skirt, a cooling gallery connected to an oil inlet/outlet, two gas ring grooves, and one oil ring groove. The piston head and the piston skirt are made of forged steel. The piston head is fixedly connected to the piston skirt. The cooling gallery is disposed between the piston head and the piston skirt. The gas ring grooves and the oil ring groove are disposed on the piston skirt, and the oil ring groove is below the gas ring grooves. The piston skirt includes a pin boss; the upper end of the pin boss is connected to the lower end of the piston head via a screw thread. The top circle of the upper end of the piston head and the inner chamber of the top land of the piston skirt are coupled by an interference fit.

### CROSS-REFERENCE TO RELATED APPLICATIONS

This application is a continuation-in-part of International Patent Application No. PCT/CN2014/001121 with an international filing date of Dec. 15, 2014, designating the United States, now pending, and further claims foreign priority benefits to Chinese Patent Application No. 201410223859.9 filed May 26, 2014. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND OF THE INVENTION

Field of the Invention

The invention relates to a forged steel piston.

Description of the Related Art

Conventional aluminum pistons only work at temperatures under 350° C. On the other hand, ceramic pistons are heavy, costly, and difficult to cool. In addition, the piston head and the piston skirt of conventional pistons are welded using friction welding which is costly. Also, the welding seam on the inner side of the sealed oil chamber cannot be cleaned, which leads to scuffing of the cylinder.

### SUMMARY OF THE INVENTION

In view of the above-described problems, it is one objective of the invention to provide a forged steel piston that can be efficiently cooled and a welding attachment between the piston head and the piston skirt that is stable and reliable.

To achieve the above objective, in accordance with one embodiment of the invention, there is provided a forged steel piston, comprising a piston head, a piston skirt, a cooling gallery connected to an oil inlet/outlet, two gas ring grooves, and one oil ring groove. The piston head and the piston skirt are made of forged steel. The piston head is fixedly connected to the piston skirt. The cooling gallery is sealed, disposed between the piston head and the piston skirt, and communicates with outside via the oil inlet/outlet. The gas ring grooves and the oil ring groove are disposed on the piston skirt, and the oil ring groove is below the gas ring grooves. The piston skirt comprises a pin boss; an upper end of the pin boss is connected to a lower end of the piston head via a screw thread. A top circle of an upper end of the piston head and an inner chamber of a top land of the piston skirt are coupled by an interference fit; and a top circle surface or a top surface of the piston comprises a single side welding seam.

In a class of this embodiment, a belt is disposed between the circular groove and the oil ring groove. A belt diameter is between 1 and 3 mm smaller than a cylinder hole diameter. The belt comprises a plurality of oil return holes, and the oil ring groove communicates with the circular groove via the oil return holes; or an oil return blind hole is horizontally disposed on a surface of the oil ring groove. Because the oil ring groove communicates with the circular groove via the oil return holes, the piston is light in weight, and the flexibility of the piston skirt is improved. In addition, the oil return of the oil ring groove is favorable. Especially, the oil is directly returned from the bottom of the oil ring groove to the circular groove via the oil return holes, or the oil is returned from the belt which has a smaller diameter on a lower side surface of the oil ring groove to the circular groove via the oil return blind hole on a side surface of the oil ring groove, thus preventing oil scattering caused by high pressure, reducing the oil consumption, and decreasing the harmful emissions of the engine.

In a class of this embodiment, the oil return hole is disposed in the vicinity of a minor axis of the piston.

In a class of this embodiment, the oil return blind hole is disposed in the vicinity of a major axis of the piston.

In a class of this embodiment, the oil return hole is parallel to an axis of the piston.

In a class of this embodiment, the circular groove communicates with the inner chamber of the piston along a direction of the major axis of the piston. According to the embodiments of the invention, on the one hand, the piston is light in weight, and the engine damage caused by inertia force of the piston during the operation is reduced; on the other hand, the thermal transmission from the piston head to the piston skirt is decreased, thus the probability of thermal fatigue failure of the piston skirt is reduced.

In a class of this embodiment, a pin shaft sleeve is mounted in the pin hole on the pin boss, thus reducing the abrasion of the pin shaft.

In a class of this embodiment, the pin shaft sleeve is made of casting bronze.

In a class of this embodiment, a cross-section of the pin hole on the pin boss is hyperbolic-shaped. During an operation of the piston, a piston pin is compressed by the piston rod and is bended upwards, and the pin hole is influenced by the force of the piston pin. While a liner pin hole results in fatigue cracking of the pin boss, the pin hole in the embodiments of the invention is hyperbolic-shaped, thus the stress concentration is reduced, and pin hole cracking caused by high pressure is effectively avoided.

Advantages of the forged steel piston according to embodiments of the invention are summarized as follows:

1. The piston head is connected to the piston skirt via a screw thread, and thus the connection is reliable. In addition, the top circle of the upper end of the piston head and the inner chamber of the top land of the piston skirt are coupled by an interference fit, which improves the reliability of the connection between the piston head and the piston skirt. The welding seam on the top circle surface or on the top surface of the piston can be welded using common welding or argon-arc welding. The welding process is simple and economical. Because no welding seam is formed in the cooling gallery, hard particles are not generated in the cooling gallery during the engine operation, and the probability of engine scuffing is decreased.

2. When in use, the piston tends to get stuck, especially during power stroke, the flywheel, under inertia effect, drives piston rod which further drives the piston skirt to move downwards, meanwhile the piston ring brings a great tension force to the upper side surface of the ring grooves. As a result, the piston head and the piston skirt separate from each other, and the engine is damaged. The ring grooves in the embodiments of the invention are disposed on the piston skirt, thus decreasing the probability of engine damage.

3. The pin boss bears great pressure during operation, and 30% of piston failure is caused by the fatigue cracking of the pin boss. The pin boss in the embodiments of the invention is connected to the piston head using a screw thread, thus buffering the deformation of the pin boss, and reducing the probability of the fatigue cracking of the pin boss.

### BRIEF DESCRIPTION OF THE DRAWINGS

The invention is described hereinbelow with reference to the accompanying drawings, in which:

FIG. 1 is a front cross-sectional view of a forged steel piston in accordance with one embodiment of the invention;

FIG. 2 is a side cross-sectional view of a forged steel piston in accordance with one embodiment of the invention;

FIG. 3 is a bottom view of a forged steel piston in accordance with one embodiment of the invention;

FIG. 4 is a schematic diagram of a forged steel piston in accordance with one embodiment of the invention; and

FIG. 5 is a cross-sectional of a hyperbolic-shaped pin hole in accordance with one embodiment of the invention.

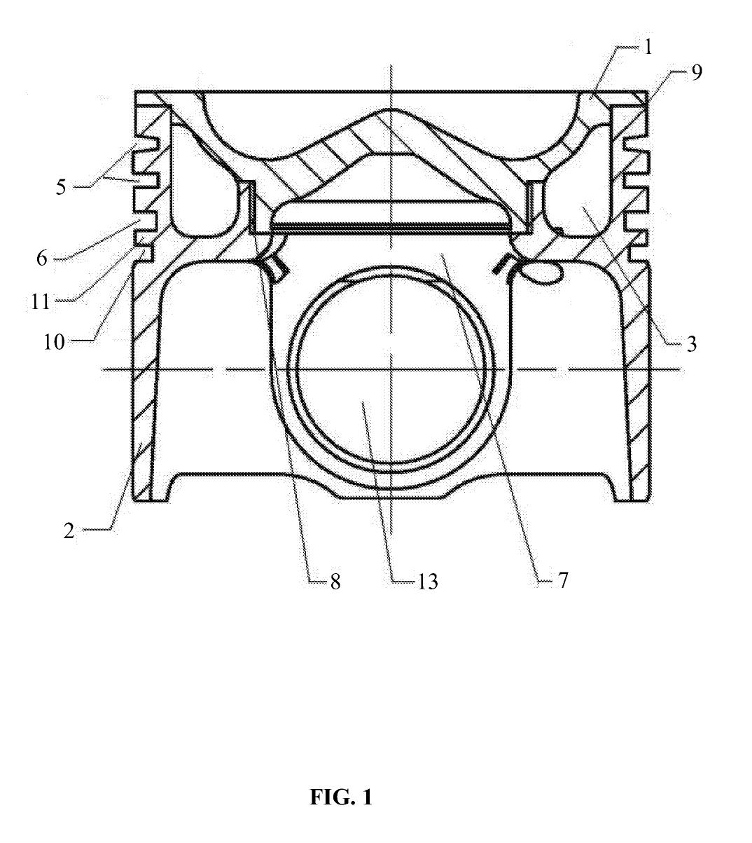

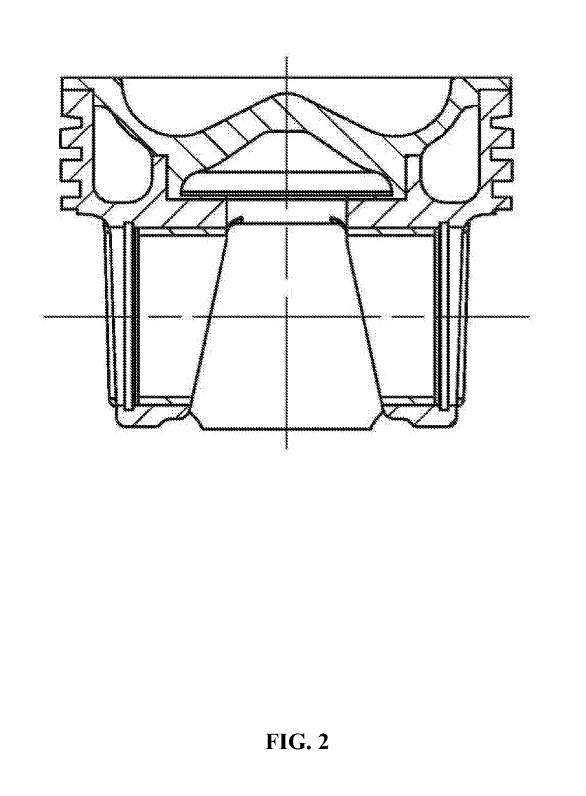

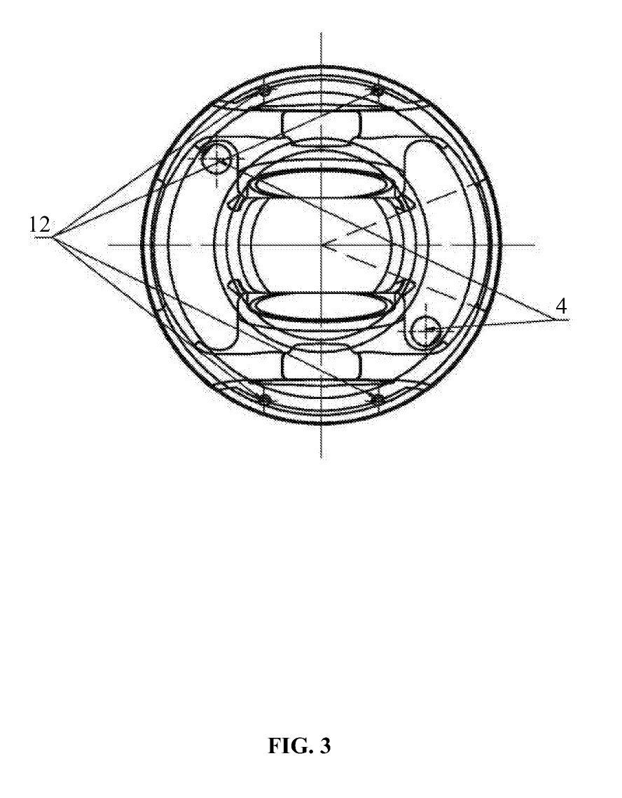

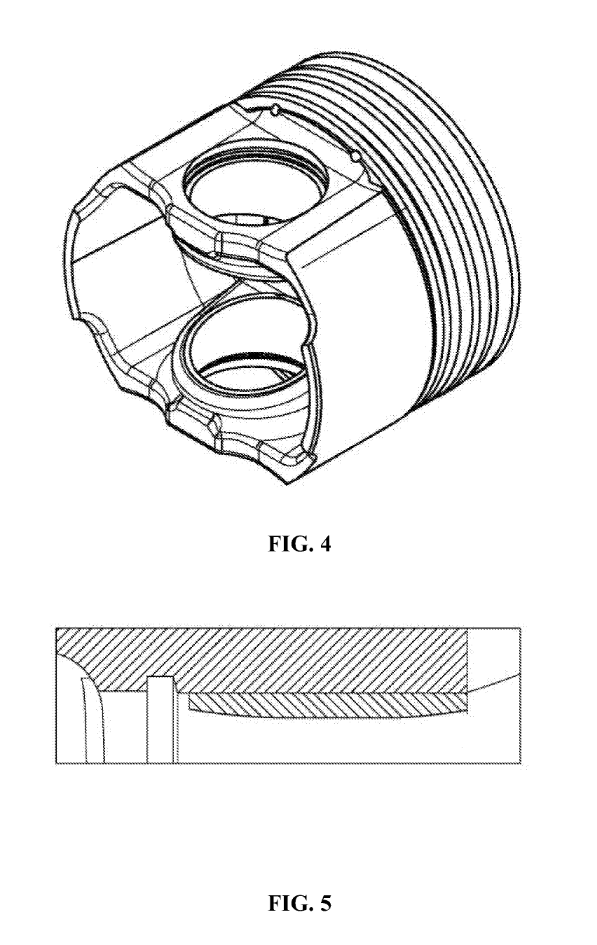

In the drawings, the following reference numbers are used: 1. Piston head; 2. Piston skirt; 3. Cooling gallery; 4. Oil inlet/outlet; 5. Gas ring groove; 6. Oil ring groove; 7. Pin boss; 8. Screw thread; 9. Single side welding seam; 10. Circular groove; 11. Belt; 12. Oil return hole; and 13. Pin hole.

### DETAILED DESCRIPTION OF THE EMBODIMENTS

For further illustrating the invention, experiments detailing a forged steel piston are described below. It should be noted that the following examples are intended to describe and not to limit the invention.

A forged steel piston comprises a piston head 1 and a piston skirt 2. The piston head and the piston skirt are made of forged steel. The piston comprises two gas ring grooves 5 and an oil ring groove 6. The gas ring grooves and the oil ring groove are disposed on the piston skirt 2. A pin boss 7 is disposed on the piston skirt 2. An upper end of the pin boss 7 is connected to a lower end of the piston head 1 via a screw thread 8. A top circle of an upper end of the piston head 1 and an inner chamber of a top land of the piston skirt 2 are coupled by an interference fit. A top circle surface or a top surface of the piston comprises a single side welding seam 9. A closed cooling gallery 3 is disposed between the piston head 1 and the piston skirt 2. The cooling gallery is provided with an oil inlet/outlet 4.

A circular groove 10 is disposed below the oil ring groove 6, and a belt 11 is disposed between the circular groove 10 and the oil ring groove 6. A diameter of the belt 11 is smaller than a cylinder hole diameter. The belt 11 comprises a plurality of oil return holes 12, and the oil ring groove 6 communicates with the circular groove 10 via the oil return holes. The oil return hole 12 is disposed in the vicinity of a minor axis of the piston.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A piston, comprising:
a piston head;
a piston skirt;
a cooling gallery connected to an oil inlet/outlet;
two gas ring grooves; and
one oil ring groove;
wherein
the piston head and the piston skirt are made of forged steel; the piston head is fixedly connected to the piston skirt;
the cooling gallery is sealed, disposed between the piston head and the piston skirt, and communicates with outside via the oil inlet/outlet;
the gas ring grooves and the oil ring groove are disposed on the piston skirt, and the oil ring groove is below the gas ring grooves;
the piston skirt comprises a pin boss; an upper end of the pin boss is connected to a lower end of the piston head via a screw thread;
a top circle of an upper end of the piston head and an inner chamber of a top land of the piston skirt are coupled by an interference fit; and
a top circle surface or a top surface of the piston comprises a single side welding seam.

2. The piston of claim 1, wherein a circular groove is disposed below the oil ring groove on the piston skirt; a belt is disposed between the circular groove and the oil ring groove; a diameter of the belt is smaller than a cylinder hole diameter; the belt comprises at least one oil return hole, and the oil ring groove communicates with the circular groove via the oil return hole; or an oil return blind hole is disposed horizontally on a lower surface of the oil ring groove.

3. The piston of claim 2, wherein the oil return hole is disposed in the vicinity of a minor axis of the piston.

4. The piston of claim 2, wherein the oil return blind hole is disposed in the vicinity of a major axis of the piston.

5. The piston of claim 2, wherein the oil return hole is parallel to an axis of the piston.

6. The piston of claim 2, wherein the circular groove communicates with the inner chamber along a direction of a major axis of the piston.

7. The piston of claim 1, wherein the pin boss is provided with a pin hole; and a pin shaft sleeve is mounted in the pin hole.

8. The piston of claim 2, wherein the pin boss is provided with a pin hole; and a pin shaft sleeve is mounted in the pin hole.

9. The piston of claim 3, wherein the pin boss is provided with a pin hole; and a pin shaft sleeve is mounted in the pin hole.

10. The piston of claim 4, wherein the pin boss is provided with a pin hole; and a pin shaft sleeve is mounted in the pin hole.

11. The piston of claim 5, wherein the pin boss is provided with a pin hole; and a pin shaft sleeve is mounted in the pin hole.

12. The piston of claim 7, wherein the pin shaft sleeve is made of casting bronze.

13. The piston of claim 8, wherein the pin shaft sleeve is made of casting bronze.

14. The piston of claim 9, wherein the pin shaft sleeve is made of casting bronze.

15. The piston of claim 10, wherein the pin shaft sleeve is made of casting bronze.

16. The piston of claim 1, wherein the pin boss is provided with a pin hole; a cross-section of the pin hole is hyperbolic-shaped.

17. The piston of claim 2, wherein the pin boss is provided with a pin hole; a cross-section of the pin hole is hyperbolic-shaped.

18. The piston of claim 3, wherein the pin boss is provided with a pin hole; a cross-section of the pin hole is hyperbolic-shaped.

19. The piston of claim 4, wherein the pin boss is provided with a pin hole; a cross-section of the pin hole is hyperbolic-shaped.

20. The piston of claim 6, wherein the pin boss is provided with a pin hole; a cross-section of the pin hole is hyperbolic-shaped.
